(19) United States
(12) Patent Application Publication
(10) Pub. No.: US 2024/0340680 A1
(43) Pub. Date: Oct. 10, 2024

(54) SELECTIVE LEARNING FOR UE REPORTED VALUES

(71) Applicant: Nokia Solutions and Networks Oy, Espoo (FI)

(72) Inventors: Kalle Petteri KELA, Espoo (FI); Teemu Mikael VEIJALAINEN, Espoo (FI); Hans Thomas HÖHNE, Espoo (FI)

(21) Appl. No.: 18/681,750

(22) PCT Filed: Aug. 27, 2021
(86) PCT No.: PCT/EP2021/073764

§ 371 Date: Feb. 6, 2024

(51) Int. Cl. H04W 24/10

(52) U.S. Cl. CPC H04W 24/10

(57) ABSTRACT

A method includes transmitting an indication of support of learning reporting information; receiving a configuration related to the learning of the reporting information, the configuration comprising at least one parameter related to exploration of the reporting information; initiating the exploration of the reporting information to activate the learning of the reporting information; varying at least one value of the reporting information, based on the at least one parameter, to learn the at least one value of the reporting information; and reporting the at least one value of the reporting information during the learning or following a deactivation of the learning of the at least one value of the reporting information.

### TECHNICAL FIELD

The examples and non-limiting embodiments relate generally to communications and, more particularly, to selective learning for UE reported values.

### BACKGROUND

It is known for a user equipment to report a channel quality indicator related to link quality in a communication network.

### SUMMARY

In accordance with an aspect, a method includes transmitting an indication of support of learning reporting information; receiving a configuration related to the learning of the reporting information, the configuration comprising at least one parameter related to exploration of the reporting information; initiating the exploration of the reporting information to activate the learning of the reporting information; varying at least one value of the reporting information, based on the at least one parameter, to learn the at least one value of the reporting information; and reporting the at least one value of the reporting information during the learning or following a deactivation of the learning of the at least one value of the reporting information.

In accordance with an aspect, a method includes receiving an indication of support of learning reporting information; transmitting a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and receiving reporting of the at least one value of the reporting information during the learning or following a deactivation of the learning of the at least one value of the reporting information.

In accordance with an aspect, an apparatus includes at least one processor; and at least one memory including computer program code; wherein the at least one memory and the computer program code are configured to, with the at least one processor, cause the apparatus at least to: transmit an indication of support of learning reporting information; receive a configuration related to the learning of the reporting information, the configuration comprising at least one parameter related to exploration of the reporting information; initiate the exploration of the reporting information to activate the learning of the reporting information; vary at least one value of the reporting information, based on the at least one parameter, to learn the at least one value of the reporting information; and report the at least one value of the reporting information during the learning or following a deactivation of the learning of the at least one value of the reporting information.

In accordance with an aspect, an apparatus includes at least one processor; and at least one memory including computer program code; wherein the at least one memory and the computer program code are configured to, with the at least one processor, cause the apparatus at least to: receive an indication of support of learning reporting information; transmit a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and receive reporting of the at least one value of the reporting information during the learning or following a deactivation of the learning of the at least one value of the reporting information.

In accordance with an aspect, an apparatus includes means for transmitting an indication of support of learning reporting information; means for receiving a configuration related to the learning of the reporting information, the configuration comprising at least one parameter related to exploration of the reporting information; means for initiating the exploration of the reporting information to activate the learning of the reporting information; means for varying at least one value of the reporting information, based on the at least one parameter, to learn the at least one value of the reporting information; and means for reporting the at least one value of the reporting information during the learning or following a deactivation of the learning of the at least one value of the reporting information.

In accordance with an aspect, an apparatus includes means for receiving an indication of support of learning reporting information; means for transmitting a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and means for receiving reporting of the at least one value of the reporting information during the learning or following a deactivation of the learning of the at least one value of the reporting information.

In accordance with an aspect, a non-transitory program storage device readable by a machine, tangibly embodying a program of instructions executable with the machine for performing operations is provided/described, the operations comprising: transmitting an indication of support of learning reporting information; receiving a configuration related to the learning of the reporting information, the configuration comprising at least one parameter related to exploration of the reporting information; initiating the exploration of the reporting information to activate the learning of the reporting information; varying at least one value of the reporting information, based on the at least one parameter, to learn the at least one value of the reporting information; and reporting the at least one value of the reporting information during the learning or following a deactivation of the learning of the at least one value of the reporting information.

In accordance with an aspect, a non-transitory program storage device readable by a machine, tangibly embodying a program of instructions executable with the machine for performing operations, the operations comprising: receiving an indication of support of learning reporting information; transmitting a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and receiving reporting of the at least one value of the reporting information during the learning or following a deactivation of the learning of the at least one value of the reporting information.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example signaling diagram comprising tuning reported CQI values through learning.

FIG. 3 shows a state diagram comprising states of learning reported values.

FIG. 4 is a flow chart of UE actions.

FIG. 5 is a UE flow chart when sending normal and exploration CQIs in parallel.

FIG. 6 is a graphical representation illustrating that the described method improves reliability and decreases latencies for any type of CQI reporting method.

FIG. 7 is a block diagram of an apparatus configured to implement the examples described herein.

FIG. 8 is a flowchart of an example method performed with a user equipment to implement the examples described herein.

FIG. 9 is a flowchart of an example method performed with a radio node (e.g. gNB) to implement the examples described herein.

### DETAILED DESCRIPTION OF EXAMPLE EMBODIMENTS

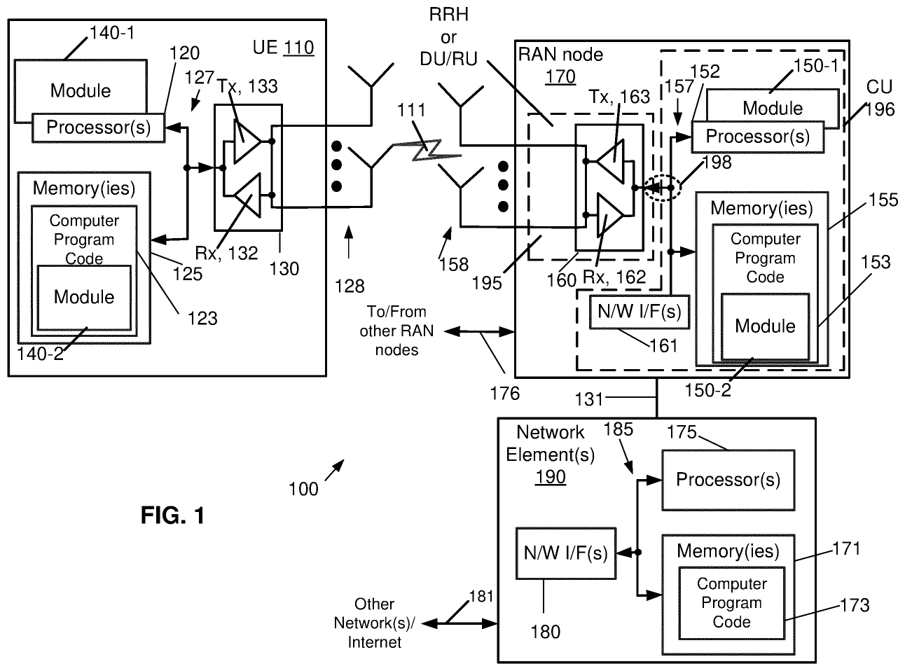

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with PAN node 170 via a wireless link 111.

The PAN node 170 in this example is a base station that provides access by wireless devices such as the UE 110 to the wireless network 100. The PAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the PAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMFF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, PAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

UE 110, RAN node 170, and/or network element(s) 190, (and associated memories, computer program code and modules) may be configured to implement (e.g. in part) the methods described herein, including selective learning for UE reported values. Thus, computer program code 123, module 140-1, module 140-2, and other elements/features shown in FIG. 1 of UE 110 may implement user equipment related aspects of the methods described herein. Similarly, computer program code 153, module 150-1, module 150-2, and other elements/features shown in FIG. 1 of PAN node 170 may implement gNB/TRP related aspects of the methods described herein, such as for a gNB. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

The examples described herein introduce a new CSI/CQI reporting framework, including a machine learning technique at the UE side to improve performance at the UE and a network/cell that provides access to a communication network. The described solution introduces different states for reporting CQI measurements at the UE which are configured and controlled by the network node/base station (gNB). The base station configures normal CQI reporting and additionally phases for exploration reporting and learning reporting. During the exploration and learning period, the UE explores the transmission results. The examples described herein further introduce a new IE for configuring the UE to execute exploration and the learning phase, a new IE to report new exploration and learning measurements/results, and a new IE to indicate UE and network capabilities for this new framework.

The examples described herein are related to further improving 3GPP REL17 CQI reporting and link adaptation. It has been identified that current CQI reporting and link adaptation methods are not sufficient e.g. for URLLC and AR/VR. Therefore, new CQI reporting methods have been proposed in 3GPP.

After having studied CQI reporting enhancements being proposed, it has been observed that there is room for further enhancements that can be achieved with machine learning (e.g. reinforcement learning) or other advanced adaptation algorithms.

The idea in reinforcement learning is to choose an action in an environment that maximizes the notion of cumulative reward. However, a balance between exploration (of uncharted territory) and exploitation (of current knowledge) should be found. In exploration the algorithm tries actions that might not always yield the desired outcome, but that allows learning. In exploitation the algorithm utilizes its best knowledge to choose the best action for the current state.

Even though new CQI reporting methods being proposed are proven to enhance currently standardized methods, those methods can be pushed to reach even better performance, especially with the help of machine learning, which can take individual problematic UEs better into account.

It has been identified that usually there are a subset of UEs that are the primary causes of overall performance degradation in a loaded network. For these UEs, various ML methods can be used to learn adequate offsets for their CQI reports. However, there are problems to be solved to make it practical, because the exploration phase used for learning a CQI offset may cause: delays due to increased load (caused by unnecessary robust MCSs), and/or interference due to increased PRB usage.

Hence, not all UEs can do CQI exploration simultaneously. Only UEs that are seen to benefit from CQI exploration may utilize the proposed method. Said problems are especially relevant in live networks where careful learning has to happen on-the-go with live date during normal operation in a decent/sufficient time and in such a way that learning does not jeopardize transmission reliability or packet delays of other UEs.

The idea of the examples described herein is not necessarily to find exact learning algorithms or improve existing learning algorithms, but rather to propose novel and inventive (algorithm agnostic) solutions (proven to work) to problems faced when trying to improve prior-art CSI reporting methods being currently defined or proposed for 3GPP standards.

Prior art methods for channel state information (CSI) and channel quality indicator (CQI) reporting and link adaptation are described. Machine learning related techniques are not currently considered. However, CSI prediction has been mentioned, but a machine learning framework is not yet provided.

In order to allow machine learning based channel state information (CSI), the gNB has to control carefully especially exploration of CSI. Otherwise, UEs may cause interference peaks that cause distortion to learning as well as load that degrades network performance. The examples described herein concentrate on the channel quality indicator (CQI), but similar methods may be used for other CSI reporting or completely other types of reporting purposes as well.

In particular, described herein is a gNB controlled method where the gNB may grant exploration permission to selected UE(s) only. This may be called selective learning for UE reporting. These selected UEs are considered to be the most beneficial for learning exploration or other learning purposes. Either they can become more spectral efficient or robust by themselves or they are may be considered to be bottlenecking the network performance the most.

Roughly speaking CQI is defined as the highest (i.e. most spectral efficient) MCS that can achieve a desired block error rate (BLER) target. This reporting is based on the UE's signal-to-interference-plus-noise ratio (SINR) measurements. When the network receives a CQI report it is already outdated and does not take long term benefits or any prediction into account. The aim of the method described herein is to explore and exploit the CQI offset for UEs that are not meeting desired target(s) (such as BLER or delay) in a way that overall network performance is not jeopardized. Since the network is choosing the UE's transmission configuration, at least partially, based on CSI feedback, the additional CQI offset causes the network to choose a more reliable or spectrally efficient configuration. For instance, a negative offset would act as a safety margin, artificially decreasing the CQI, making the network select a more robust transmission configuration. The UE learns the offset via the exploration phase by utilizing its (the UE's) internal measurements such as interference patterns or measured BLEP/SINR values at the decoder output.

In one embodiment, the gNB may grant an exploration window during which the UE is allowed to do the exploration. Such time window may be defined e.g. as a period of time, or as n consecutive CSI reports or data transmissions. Alternatively the gNB may grant exploration permission for the time being and the exploration permission may be deactivated by the gNB or UE later. In yet another embodiment the UE may trigger exploration to start autonomously (within configured boundaries) and advance towards exploitation.

The UE may maintain the same exploration offset between DL data transmissions if the CQI is reported more frequently than data is received. This ensures that the network is using the explored offset for selecting the MCS. After reception the UE may learn from the reception outcome i.e. how that particular CQI offset affected downlink data transmission.

In another embodiment, the manner in which CSI and learning outcomes are reported from the UE to the network are defined.

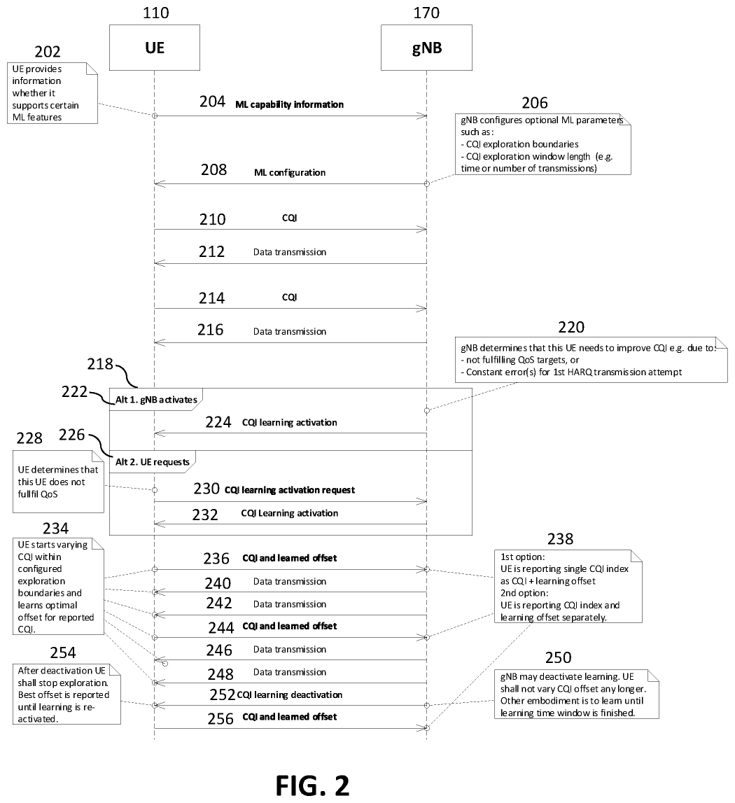

In FIG. 2 basic embodiments of the described method are given in the form of a message sequence chart. First the UE provides information on its capabilities, e.g. whether it supports exploration reporting or other ML features (202, 204). For capable UEs the network provides a configuration where exploration and/or learning parameters are provided (206, 208). These parameters may include e.g. boundaries for learning and exploration window length (206). Exploration window length may be provided e.g. by indicating a time window or a number of consecutive transmissions during which the UE is allowed to vary its reporting behavior (206, 208). Alternatively or additionally, another window may define a length of time, during which the UE 110 has to keep the explored offset fixed during the exploration. Such averaging window might be beneficial if the gNB 170 has an averaging filter for the CQI. So the offset needs to stay fixed to observe its influence over the averaging window. Moreover, the UE 110 may keep the explored offset fixed between downlink data transmissions if reports are done more frequently than data is received.

In the illustrated CQI example the UE may vary reported CQI within given minimum and maximum offset values once exploration for learning is initiated. The most logical option is to provide learning boundaries in the form of CQI index steps, but other boundaries can be used as well, e.g. expected block error rate (BLER) or measured SINR from which the CQI index is derived. Exploration may be initiated e.g. due to network command (222), UE request (226) or autonomously with trigger. In case of CQI reporting, such trigger may be e.g. cyclic redundancy check (CRC) error i.e. erroneous data reception. Alternatively, the CSI report may include a request from the UE to the network for starting exploration, or the CSI report may indicate that UE started autonomously exploration due to a trigger event. Other options carrying such information may be e.g. a MAC CE. The network may indicate exploration start e.g. with downlink control information (DCI) or a MAC CE.

In another embodiment, every CQI contains an indication whether the CQI is for exploration. This allows the UE to have normal CQI and exploration mode CQI reporting performed in parallel.

During the exploration/learning the UE may learn reported CQI values that would provide better downlink performance in terms of spectral efficiency, reliability as well as latency. In one embodiment, the network provides the downlink performance criteria for the UE, so that the UE can provide feedback for its internal learning algorithm during the exploration. In one example the network provides BLEP and BLEP outage targets, meaning a certain percentage of the transmissions should be below a certain BLEP target (e.g. 99% below 10e-5 BLEP). The UE can then estimate BLEP(s) of PDSCH transmissions during exploration to determine if the explored offset satisfied the given performance criteria. Another simple example of such learning is to use commonly known rewarding of made actions. For example if transmission after using a certain CQI offset is successful and within a packet delay budget, the UE may give a positive reward for the selected CQI offset. Another example could be e.g. measuring signal-to-interference-plus-noise ratio (SINR) during the transmission, and deriving a packet error probability (PEP) by means of link to system mapping with a measured SINR and modulation and coding scheme (MCS) network assigned for the transmission. If the reliability target is e.g. 0.99999, then reward r for the CQI offset could be e.g.:

$$r = 1 - \frac{\vert {log}_{10} ( P E P ) - {log}_{10} ( {PEP}_{target} ) \vert}{10} , \qquad ( Equation 1 )$$

where e.g. 10⁻¹¹≤PEP≤0.1. It should be noted that only a few examples are given as to how learning and rewarding may be implemented. It is important that network grants permission and provides boundaries for learning (or for another algorithm trying to seek the desired performance). Otherwise, if learning is not network controlled, UEs may cause uncontrolled interference and radio resource usage overloading. This causes distortion to learning and degrades network performance. In the end, used learning methods may be left up to UE implementation, but according to studies performed by the inventors of the examples described herein, network control may provide for allowing exploration for only a subset of users at a time. Hence, by controlling boundaries for learning, overloading, extensive interference, and increased delays can be avoided.

Accordingly, FIG. 2 is a signaling diagram between the UE 110 and the gNB 170, showing specifically an example of tuning reported CQI values through learning. At 202 and 204, the UE 110 transmits ML capability information to the gNB 170, including providing information of whether the UE supports certain ML features. At 206, the gNB configures optional ML parameters such as CQI exploration boundaries or a CQI exploration window length. The CQI exploration window length may be for example a time or a number of transmissions. At 210, the UE 110 transmits a CQI to the gNB 170. At 212, the gNB 170 transmits data to the UE 110. At 214, the UE 110 transmits a CQI to the gNB 170. At 216, the gNB 170 transmits data to the UE 110.

At 218, CQI learning is activated by one of two alternatives, 222 and 226. In the first alternative 222 (comprising items 220 and 224), the gNB activates CQI learning. At 220, the gNB 170 determines that the UE 110 needs to improve CQI e.g. due to not fulfilling QoS targets, or due to one or more constant error(s) for a first HARQ transmission attempt. At 224, the gNB 170 transmits an indication of CQI learning activation to the UE 110. In the second alternative 226 (comprising items 228, 230, and 232), the UE requests CQI learning activation from the gNB 170. At 228, the UE 110 determines that the UE 110 does not fulfill QoS. At 230, the UE 110 transmits a CQI activation request to the gNB 170. At 232, the gNB 170 transmits a CQI learning activation indication to the UE 110.

Once CQI learning is activated, at 234 the UE 110 starts varying CQI within the configured exploration boundaries and learns the optimal offset for the reported CQI. As shown in FIG. 2, item 234 happens at multiple instances, including with items 236, 240, 242, 244, 246, and 248. As indicated at 238, there are two options. In the first option (236, 240, 242), the UE 110 is reporting a single CQI index as the CQI and the learning offset together (e.g. CQI+learning offset). In the second option (244, 246, 248), the UE 110 is reporting the CQI index and learning offset separately. Thus, at 236, the UE 110 transmits to the gNB 170 the CQI and learned offset together. At 240 and 242, the gNB 170 transmits data to the UE 110. At 244, the UE 110 transmits to the gNB 170 the CQI and learned offset separately. At 246 and 248, the gNB 170 transmits data to the UE 110.

At 250, the gNB 170 may deactivate learning, where the UE 110 does not vary the CQI offset any longer. Thus at 252, the gNB 170 transmits to the UE 110 a CQI learning deactivation indication. Alternatively at 250, in another embodiment, the UE learns until a learning time window is finished and therefore the transmission at 252 to deactivate CQI learning is not needed. At 254, after deactivation the UE 110 stops exploration, and a best offset is reported until learning is reactivated. Therefore at 256, the UE 110 transmits to the gNB 170 the CQI and learned offset (e.g. the best offset).

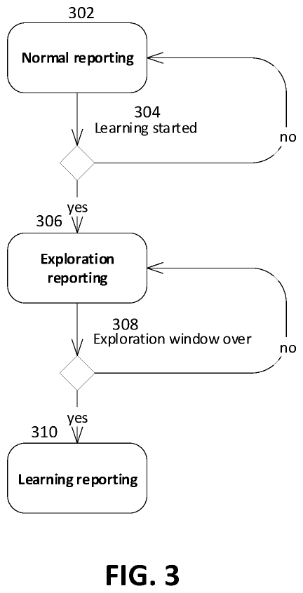

In principle the UE 110 may have e.g. 3 states for reporting values (such as CQI indexes). As depicted in FIG. 3, the UE begins with normal reporting (302) as configured by the network. Once learning is configured and started (304), the UE may move to the exploration phase (306) where the UE is allowed to vary reported values within configured boundaries. In the new exploration reporting mode (306) the UE may report CQI indexes which are not meeting the normal CQI requirements, for instance reaching a 10% or 0.001% BLER when using the indicated MCS. As described earlier, learning boundaries can be network controlled min and max values (e.g. given in CQI index steps) the UE is allowed to use for exploration. Hence, with said boundaries the network may also control whether it wants the UE to explore more reliable or more spectral efficient options, or whether the UE should explore both directions. During the exploration (306) it is expected that the network shall utilize reported CQIs for MCS selection in a consistent manner in order to make learning possible. Once the exploration window is over (308) or discontinued by the network or UE itself (308), the UE 110 may continue learning, but the UE reports (e.g. at 310) only values that are considered to be the best. In this state (310) the UE may no longer for example vary randomly reported values such as CQI offsets.

FIG. 3 also shows a loop where if learning has not started via a determination (e.g. by the UE 110 or gNB 170) at 304, normal reporting (302) is continued. FIG. 3 also shows a loop where if the exploration window is not over (determined at 308 by e.g. the UE 110 or gNB 170)), the UE continues exploration reporting (306).

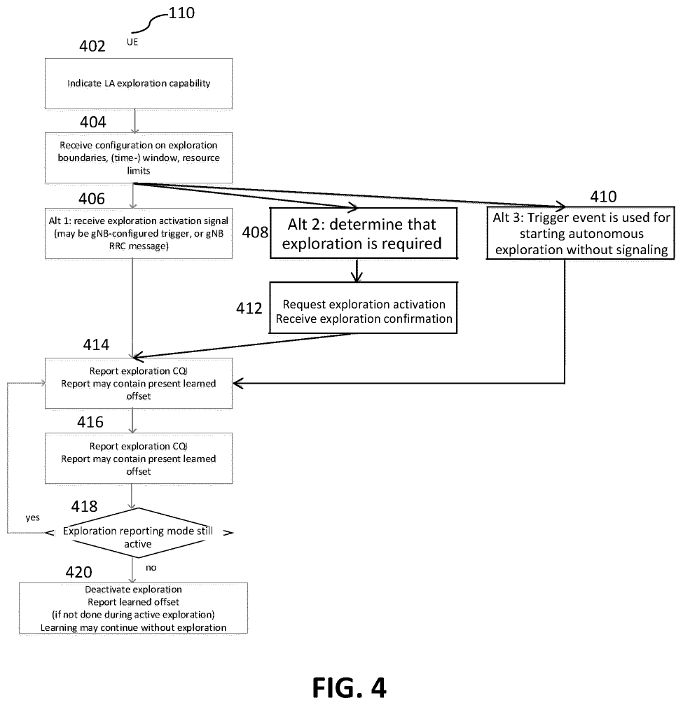

A flow chart illustrating the UE actions of the signaling chart in FIG. 2 is shown in FIG. 4.

Accordingly, FIG. 4 shows a flow chart of actions performed by the UE 110. At 402, the UE 110 indicates (e.g. to the gNB 170) learning algorithm (LA) exploration capability. At 404, the UE receives (e.g. from the gNB 170) a configuration on exploration boundaries, a time, a window, and/or resource limits. Learning is activated via three alternatives (406, 408, 410). In a first alternative 406, the UE receives (e.g. from the gNB 170) an exploration activation signal. The exploration activation signal may be a gNB-configured trigger, or a gNB RRC message. In a second alternative 408, the UE 110 determines that exploration should be performed. Following the determination at 412, the UE 110 requests (e.g. from the gNB 170) exploration activation and receives (e.g. from the gNB 170) exploration confirmation. In a third alternative 410, a trigger event is used for starting autonomous exploration without signaling.

Following either of items 406, 412, and 410, the method transitions to 414. At 414, the UE reports (e.g. to gNB 170) the exploration CQI, where the report may contain the present learned offset. At 416, the UE again reports (e.g. to gNB 170) the exploration CQI, where the report may contain the present learned offset. At 418, the UE 110 determines whether the exploration reporting mode is still active. If at 418 the UE determines that the exploration reporting mode is still active (e.g. “yes”), the method transitions back to 414. If at 418 the UE determines that the exploration reporting mode is not still active (e.g. “no”), the method transitions to 420. At 420, the UE deactivates exploration and reports (e.g. to the gNB 170) the learned offset, if for example the learned offset has not been reported during active exploration. As indicated at 420, learning may continue without exploration.

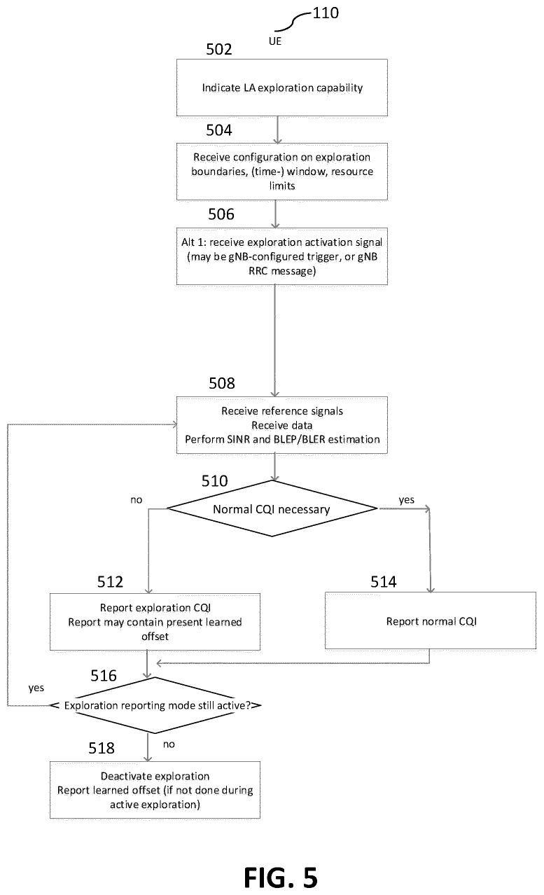

In one embodiment each CQI may contain an indication whether the CQI is an exploration CQI. This allows for the UE to send exploration and normal CQIs in parallel. The slightly modified flowchart then looks as shown in FIG. 5. The advantage of this proceeding lies in the possibility for spectral efficiency optimization. The network may not want to use the most robust MCSs for exploration if packet sizes are large and sending such packets with the most robust MCS would cause overloading within a scheduled transmission time interval (TTI). In other words the network may choose whether normal CQI is necessary or not and configure the UE accordingly. If in exploration CQIs the offset is reported separately (e.g. as CQI report {normal CQI, offset}, CQI to be used=normal_CQI+offset), the gNB does not need additional normal CQI reports. Additionally, the network may signal within DCI whether MCS for this particular downlink allocation was selected with the normal or with the exploration CQI.

Accordingly, FIG. 5 is a UE flow chart when sending normal and exploration CQIs in parallel. If exploration CQI reports mention the normal CQI separately, additional normal CQI reporting is not necessary. At 502, the UE 110 indicates (e.g. to the gNB 170) learning algorithm exploration capability. At 504, the UE receives (e.g. from the gNB 170) a configuration on exploration boundaries, a time, a window, and/or resource limits. At 506 (alternative 1 such as alternative 222 shown in FIG. 2), the UE receives (e.g. from gNB 170) an exploration activation signal, where the activation signal may be a gNB-configured trigger, or an RRC message. Items 502, 504, and 506 of FIG. 5 are similar to items 402, 404, and 406, respectively, of FIG. 4.

At 508, the UE receives reference signals and data (e.g. from gNB 170), and performs SINR and BLEP/BLER estimation. At 510, the UE determines whether normal CQI reporting is necessary. If at 510 the UE determines that normal CQI reporting is not necessary (e.g. “no”), the method transitions to 512. If at 510 the UE determines that normal CQI reporting is necessary (e.g. “yes”), the method transitions to 514. At 512, the UE reports (e.g. to gNB 170) the exploration CQI, where the report may contain the present learned offset. At 514, the UE reports (e.g. to gNB 170) the normal CQI.

Following items 512 and 514, the method transitions to 516. At 516, the UE determines whether the exploration reporting mode is still active. If at 516 the UE determines that the exploration reporting mode is still active (e.g. “yes”), the method transitions back to 508. If at 516 the UE determines that the exploration reporting mode is not still active (e.g. “no”), the method transitions to 518. At 518, the UE deactivates exploration and reports (e.g. to gNB 170) the learned offset if the learned offset was not reported during active exploration.

As mentioned earlier, uncontrolled exploration may lead to high interference or overload in the network. Therefore, in addition to a time window and number of consecutive exploration transmissions the network may further configure a number of resource elements (RE) or resource blocks (RBs) that can be used within the window. For example, proposed learning of reported CQI indexes maybe configured for certain CQI reporting sub-bands only.

The network may also limit the resource consumption caused by exploration by granting separate smaller data allocations for learning purposes. It may do so by assigning the amount of exploration data that is to be used when using an exploration CQI offset from which a used MCS index was selected. For instance, for a low MCS only a few bytes of data may be used, thus avoiding utilization of all physical resource blocks (PRBs) within one slot. The rest of the data may use a separate allocation for which the CQI offset currently explored is not utilized. In case of separate allocations for learning, the network may even indicate which allocations are using the learning offset to make sure that the UE is learning from the right data transmissions.

Because the UE is capable of utilizing some knowledge from decoding of the transmissions, such as the error probability or SINR offset towards a certain BLER target, propose herein is to have learning to be at the UE end. Nevertheless, the algorithm the UE uses for learning may vary between vendors and it can be left as an implementation decision. However, in order to make it work, according to studies performed by the inventors of the method described herein, network control is needed to avoid overloading, extensive interference and increased delays. UE(s) may be configured for achieving certain BLER or delay targets and selected UE(s) may be activated to learn what is needed to achieve this. Since the offset can be different in different locations of the network, exploration may be also re-initiated from time to time during mobility if viewed as beneficial.

The main points described herein from the perspective of the UE include (1-14):

1. The UE 110 indicates its capability of learning certain reported information, and receiving a configuration for said learning. The UE receives exploration permission for learning. The UE initiates the learning exploration as granted. 2. Said reported information is CSI or CQI, in particular. 3. The exploration permission is valid during a certain time window (exploration window) or during a certain number of consecutive transmissions. 4. The exploration permission is valid until deactivated by the network or the UE itself. 5. The learning configuration defines boundaries for learning. For example in case of CQI reporting a minimum and maximum offset for the reported CQI index is defined (or other boundary such as a BLER target range or SINR measurement offset). 6. The UE receives automatic exploration permission with a trigger. Such trigger may be e.g. CRC error or a number of consecutive errors. 7. The UE may request exploration permission before receiving said permission.

8. Once the exploration window is over, the UE may continue learning, but it reports only the configured CQI as well as the best CQI offset (the UE may not vary e.g. randomly CQI offset further). 9. The UE has another time window (exploration averaging window) during which the explored offset value is kept the same within exploration. 10. The CQI offset may be calculated within a reported CQI index value. 11. The CQI offset may be reported separately with a separate offset index. 12. UEs may have different reporting states. Once in exploration state, the UE may vary reported values in order to learn. Once in learning state, the UE may continue learning, but it reports only the value(s) considered to be the best one(s). 13. The UE receives separate data allocations for learning. Said separate allocations may utilize the UE reported CQI with the explored offset for MCS selection. MCS (s) for other allocations may be given without the explored CQI offset. 14. The UE may receive information on which allocations are for learning purposes (e.g. an indication in downlink control information (DCI)).

Proof of Concept Simulations. In order to be confident that the methods described herein are indeed beneficial, several simulations were carried out with a realistic 5G system level simulator. The used simulation scenario was that being used in REL17 standardization. The effect of the herein described learning method was utilized for learning offsets for reported CQI indexes. In particular, learning was activated for UEs having the most errors for their 1st transmission attempt. These UEs were allowed to learn a CQI offset for which the lower limit was 0 db and the higher limit 5 dBs, respectively. Such dB boundaries represent roughly 2.5 CQI index steps. A Q-learning algorithm with equation (1) as a reward was used. Q-learning was implemented such that the learning rate decreased over time for each UE and CQI offset. Wideband CQI and Worst-M CQI reporting, representing the latest REL17 reliability enhancement proposals, were used for demonstrating the gain potential. More detailed simulation parameters are given in Table 1.

TABLE 1

| Parameters | Value | |
|---|---|---|
| Inter-BS distance | Macro, 500 m ISD | |
| Carrier frequency | 4 | GHz |
| UE Tx power | 23 | dBm |
| BS antenna element gain + | 8 | dBi |
| connector loss | | |
| BS receiver noise figure | 5 | dB |
| BS antenna configurations | 3GPP, (M, N, P, Mg, Ng; Mp, Np) = | |
| | (8, 2, 2, 1, 1; 1, 2) | |
| UE antenna configuration | Isotropic, (M, N, P, Mg, Ng; Mp, Np) = | |
| | (1, 2, 2, 1, 1; 1, 1) | |
| UE antenna height | Follow the modelling of TR 38.901 (e.g. 1.5 m) | |
| UE antenna gain | 0 dBi as starting point | |
| BS Tx power | 49 | dBm |
| BS receiver | MMSE-IRC as the baseline receiver | |
| UE receiver noise figure | 9 | dB |

| | |
|---|---|
| SCS | 30 kHz, i.e. 28 symbols per 1 ms |
| Simulation bandwidth | 40 MHz @ 4 GHz |
| Layout | 3GPP Macro Scenario, 7 sites, 3 sectors each |
| Channel model | 3GPP Macro 5G |
| Traffic model | FTP model 3, 10 ms mean (200 B) packet |
| | inter-arrival time |
| Number of UEs per cell | 10 UEs per cell (5 random drops) |
| | NOTE: This was used in shown PoC results, since |
| | higher numbers of UEs started to cause overloading |
| | with some random seeds. When the network was |
| | overloaded, naturally all illustrated methods provided |
| | rather similar performance not fulfilling QoS targets. |
| UE distribution | 20% of users are indoor, 3 km/h |
| HARQ | Enabled, max 6 retransmissions |
| Frame Structure | FDD, 4 symbol mini-slots |

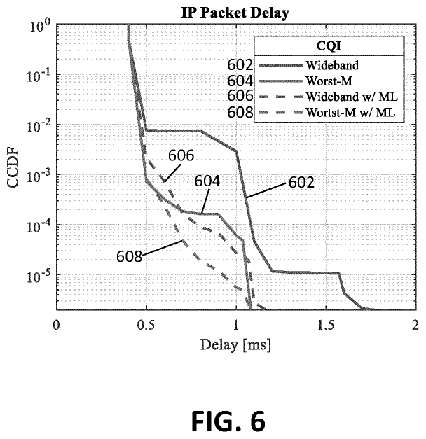

It should be remembered that the described method does not decrease the importance of REL17 CQI enhancements being currently discussed. However, as shown in FIG. 6, the herein described learning mechanisms can improve reliability as well as reduce latencies significantly even further when used together with any prior-art CQI reporting method or ones currently being discussed for 3GPP REL17. By finding better learning algorithms, improving the selection method of learning UEs, and fine tuning the reward function as well as other parameterizations we would expect even higher gains.

FIG. 6 shows that by applying learning for CQI reporting methods being discussed currently for 5G REL17, performance can be further improved. In FIG. 6, curve 602 corresponds to wideband CQI reporting, curve 604 corresponds to Worst-M CQI reporting, curve 606 corresponds to wideband with ML CQI reporting, and curve 608 corresponds to worst-M with ML CQI reporting.

As shown in FIG. 6, the only simulated method able to reach 0.99999 reliability at 1 ms delay was Worst-M CQI with proposed selective learning (refer to curve 608). It is also worth noting that even wideband CQI reporting was able to reach similar performance as Worst-M CQI when it was enhanced with selective CQI learning (refer to curve 606).

Since predictive CSI and a machine learning framework are currently being mentioned within CQI enhancement discussions, it is believed that the herein described new concepts could be relevant for future 3GPP standardization.

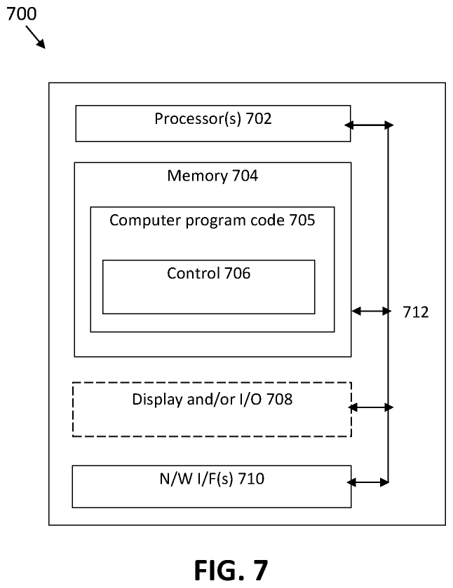

FIG. 7 is an example apparatus 700, which may be implemented in hardware, configured to implement the examples described herein. The apparatus 700 comprises at least one processor 702 (an FPGA and/or CPU), at least one memory 704 including computer program code 705, wherein the at least one memory 704 and the computer program code 705 are configured to, with the at least one processor 702, cause the apparatus 700 to implement circuitry, a process, component, module, or function (collectively control 706) to implement the examples described herein, including selective learning for UE reported values. The memory 704 may be a non-transitory memory, a transitory memory, a volatile memory, or a non-volatile memory.

The apparatus 700 optionally includes a display and/or I/O interface 708 that may be used to display aspects or a status of the methods described herein (e.g., as one of the methods is being performed or at a subsequent time), or to receive input from a user such as with using a keypad. The apparatus 700 includes one or more network (N/W) interfaces (I/F(s)) 710. The N/W I/F(s) 710 may be wired and/or wireless and communicate over the Internet/other network(s) via any communication technique. The N/W I/F(s) 710 may comprise one or more transmitters and one or more receivers. The N/W I/F(s) 710 may comprise standard well-known components such as an amplifier, filter, frequency-converter, (de)modulator, and encoder/decoder circuitries and one or more antennas.

The apparatus 700 to implement the functionality of control 706 may be UE 110, RAN node 170, or network element(s) 190. Thus, processor 702 may correspond respectively to processor(s) 120, processor(s) 152 and/or processor(s) 175, memory 704 may correspond respectively to memory(ies) 125, memory(ies) 155 and/or memory(ies) 171, computer program code 705 may correspond respectively to computer program code 123, module 140-1, module 140-2, and/or computer program code 153, module 150-1, module 150-2, and/or computer program code 173, and N/W I/F(s) 710 may correspond respectively to N/W I/F(s) 161 and/or N/W I/F(s) 180. Alternatively, apparatus 700 may not correspond to either of UE 110, RAN node 170, or network element(s) 190, as apparatus 700 may be part of a self-organizing/optimizing network (SON) node, such as in a cloud. The apparatus 700 may also be distributed throughout the network 100 including within and between apparatus 700 and any network element (such as a network control element (NCE) 190 and/or the RAN node 170 and/or the UE 110).

Interface 712 enables data communication between the various items of apparatus 700, as shown in FIG. 7. For example, the interface 712 may be one or more buses such as address, data, or control buses, and may include any interconnection mechanism, such as a series of lines on a motherboard or integrated circuit, fiber optics or other optical communication equipment, and the like. Computer program code 705, including control 706 may comprise object-oriented software configured to pass data/messages between objects within computer program code 705. The apparatus 700 need not comprise each of the features mentioned, or may comprise other features as well.

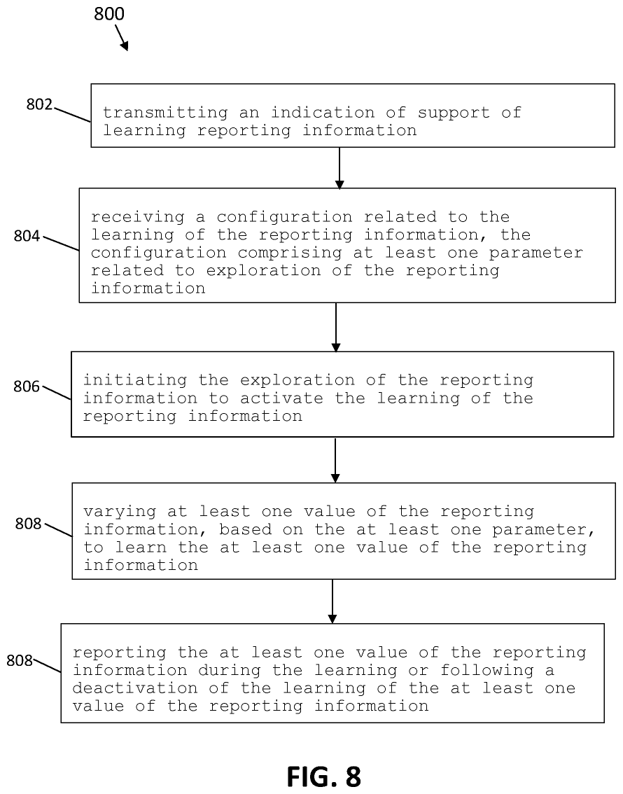

FIG. 8 is an example method 800 to implement the example embodiments described herein. At 802, the method includes transmitting an indication of support of learning reporting information. At 804, the method includes receiving a configuration related to the learning of the reporting information, the configuration comprising at least one parameter related to exploration of the reporting information. At 806, the method includes initiating the exploration of the reporting information to activate the learning of the reporting information. At 808, the method includes varying at least one value of the reporting information, based on the at least one parameter, to learn the at least one value of the reporting information. At 810, the method includes reporting the at least one value of the reporting information during the learning or following a deactivation of the learning of the at least one value of the reporting information. Method 800 may be performed with UE 110, apparatus 700, or a combination of those.

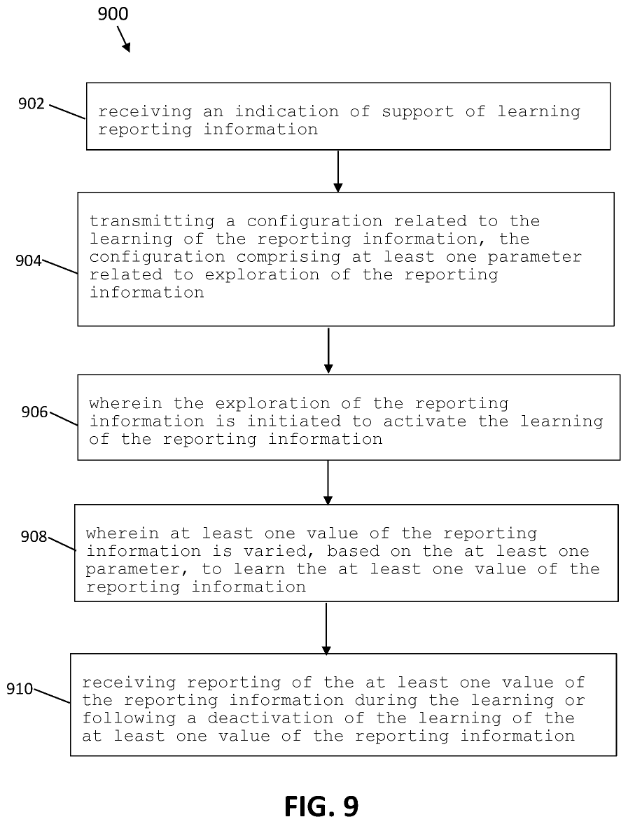

FIG. 9 is an example method 900 to implement the example embodiments described herein. At 902, the method includes receiving an indication of support of learning reporting information. At 904, the method includes transmitting a configuration related to the learning of the reporting information, the configuration comprising at least one parameter related to exploration of the reporting information. At 906, the method includes wherein the exploration of the reporting information is initiated to activate the learning of the reporting information. At 908, the method includes wherein at least one value of the reporting information is varied, based on the at least one parameter, to learn the at least one value of the reporting information. At 910, the method includes receiving reporting of the at least one value of the reporting information during the learning or following a deactivation of the learning of the at least one value of the reporting information. Method 900 may be performed with gNB 170, apparatus 700, or a combination of those.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An example method includes transmitting an indication of support of learning reporting information; receiving a configuration related to the learning of the reporting information, the configuration comprising at least one parameter related to exploration of the reporting information; initiating the exploration of the reporting information to activate the learning of the reporting information; varying at least one value of the reporting information, based on the at least one parameter, to learn the at least one value of the reporting information; and reporting the at least one value of the reporting information during the learning or following a deactivation of the learning of the at least one value of the reporting information.

The method may further include receiving exploration permission to explore learning of the at least one value of the reporting information.

The method may further include requesting exploration permission to initiate the exploration of the reporting information prior to receiving exploration permission to explore learning of the at least one value of the reporting information.

The method may further include wherein the exploration permission and the configuration are received with a user equipment from a base station.

The method may further include wherein the initiating of the exploration of the reporting information occurs upon receiving the exploration permission.

The method may further include wherein the exploration permission is valid until exploration is deactivated.

The method may further include wherein the exploration is deactivated with a network or with a user equipment.

The method may further include wherein the reporting information comprises channel state information or a subset of the channel state information, wherein the subset of the channel state information comprises a channel quality indicator.

The method may further include wherein the at least one parameter comprises a time window during which the exploration of the reporting information is to occur.

The method may further include wherein the at least one parameter comprises one or more consecutive transmissions during which the exploration of the reporting information is to occur.

The method may further include wherein the configuration comprises at least one boundary for the learning of the reporting information.

The method may further include wherein the at least one boundary comprises a minimum and maximum offset for a reported channel quality indicator index.

The method may further include wherein the at least one boundary comprises a block error ratio target range.

The method may further include wherein the at least one boundary comprises a signal to interference plus noise ratio measurement offset.

The method may further include wherein the learning is performed such that the at least one value is maintained within the at least one boundary.

The method may further include wherein the initiating of the exploration of the reporting information to activate the learning of the at least one value of the reporting information occurs in response to a trigger.

The method may further include wherein the trigger comprises a cyclic redundancy check error.

The method may further include wherein the trigger comprises one or more consecutive errors.

The method may further include continuing the learning following expiration of an exploration window.

The method may further include reporting a configured channel quality indicator and a learned channel quality indicator offset following expiration of an exploration window, without further varying the learned channel quality indicator offset following expiration of the exploration window.

The method may further include reporting the reporting information and the at least one value of the reporting information following expiration of an exploration window, without further varying the at least one value of the reporting information following expiration of the exploration window.

The method may further include wherein the at least one parameter comprises an exploration averaging window during which an explored offset value remains constant during exploration.

The method may further include wherein the at least one value is reported together with other information of the reporting information, or the at least one value comprises multiple values that are reported together.

The method may further include wherein the at least one value is reported separately from other information of the reporting information, or the at least one value comprises multiple values that are reported separately.

The method may further include wherein a channel quality indicator offset is calculated within a reported channel quality indicator index value.

The method may further include wherein a channel quality indicator offset is reported separately with a separate offset index.

The method may further include wherein a user equipment is in one of at least one reporting state, the at least one reporting state comprising a normal state, an exploration state, and a learning state.

The method may further include wherein when the user equipment is in the exploration state, the user equipment varies the at least one value of the reporting information during reporting of the reporting information to learn the at least one value of the reporting information.

The method may further include wherein when the user equipment is in the learning state, the user equipment continues learning and does not vary the at least one value of the reporting information during reporting of the reporting information.

The method may further include receiving separate data allocations for learning, said separate data allocations utilizing a user equipment reported channel quality indicator with an explored offset for selection of a modulation and coding scheme.

The method may further include wherein modulation and coding schemes for other allocations are given without the explored channel quality indicator offset.

The method may further include receiving allocation information related to which allocations are for learning purposes.

The method may further include wherein the allocation information is received within downlink control information.

The method may further include wherein the at least one value for the reporting information is learned such that the at least one value satisfies a measurement criteria.

The method may further include wherein the measurement criteria comprises a packet error probability or a signal-to-interference noise ratio.

The method may further include wherein the measurement criteria comprises a block error probability or a block error ratio.

The method may further include wherein the at least one value for the reporting information comprises an offset.

The method may further include wherein learning the at least one value of the reporting information is performed using reinforcement q-learning.

The method may further include wherein a base station deactivates the learning of the reporting information.

The method may further include wherein: a subset of one or more user equipments of a plurality of user equipments are determined to benefit most after performing learning exploration; and wherein the subset of the one or more user equipments is selected for learning exploration.

An example method includes receiving an indication of support of learning reporting information; transmitting a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and receiving reporting of the at least one value of the reporting information during the learning or following a deactivation of the learning of the at least one value of the reporting information.

The method may further include transmitting exploration permission to explore learning of the at least one value of the reporting information.

The method may further include receiving a request for the exploration permission to initiate the exploration of the reporting information prior to transmitting the exploration permission to explore learning of the at least one value of the reporting information.

The method may further include wherein the exploration permission and the configuration are transmitted from a base station to a user equipment.

The method may further include wherein the initiating of the exploration of the reporting information occurs upon transmitting the exploration permission.

The method may further include wherein the exploration permission is valid until exploration is deactivated.

The method may further include wherein the exploration is deactivated with a network or with a user equipment.

The method may further include wherein the reporting information comprises channel state information or a subset of the channel state information, wherein the subset of the channel state information comprises a channel quality indicator.

The method may further include wherein the at least one parameter comprises a time window during which the exploration of the reporting information is to occur.

The method may further include wherein the at least one parameter comprises one or more consecutive transmissions during which the exploration of the reporting information is to occur.

The method may further include wherein the configuration comprises at least one boundary for the learning of the reporting information.

The method may further include wherein the at least one boundary comprises a minimum and maximum offset for a reported channel quality indicator index.

The method may further include wherein the at least one boundary comprises a block error ratio target range.

The method may further include wherein the at least one boundary comprises a signal to interference plus noise ratio measurement offset.

The method may further include wherein the learning is performed such that the at least one value is maintained within the at least one boundary.

The method may further include wherein the initiating of the exploration of the reporting information to activate the learning of the at least one value of the reporting information occurs in response to a trigger.

The method may further include wherein the trigger comprises a cyclic redundancy check error.

The method may further include wherein the trigger comprises one or more consecutive errors.

The method may further include wherein learning is continued following expiration of an exploration window.

The method may further include receiving reporting of a configured channel quality indicator and a learned channel quality indicator offset following expiration of an exploration window, wherein the learned channel quality indicator offset is not varied following expiration of the exploration window.

The method may further include receiving reporting of the reporting information and the at least one value of the reporting information following expiration of an exploration window, wherein the at least one value of the reporting information is not further varied following expiration of the exploration window.

The method may further include wherein the at least one parameter comprises an exploration averaging window during which an explored offset value remains constant during exploration.

The method may further include wherein the at least one value is reported together with other information of the reporting information, or the at least one value comprises multiple values that are reported together.

The method may further include wherein the at least one value is reported separately from other information of the reporting information, or the at least one value comprises multiple values that are reported separately.

The method may further include wherein a channel quality indicator offset is calculated within a reported channel quality indicator index value.

The method may further include wherein a channel quality indicator offset is reported separately with a separate offset index.

The method may further include wherein a user equipment is in one of at least one reporting state, the at least one reporting state comprising a normal state, an exploration state, and a learning state.

The method may further include wherein when the user equipment is in the exploration state, the user equipment varies the at least one value of the reporting information during reporting of the reporting information to learn the at least one value of the reporting information.

The method may further include wherein when the user equipment is in the learning state, the user equipment continues learning and does not vary the at least one value of the reporting information during reporting of the reporting information.

The method may further include transmitting separate data allocations for learning, said separate data allocations utilizing a user equipment reported channel quality indicator with an explored offset for selection of a modulation and coding scheme.

The method may further include wherein modulation and coding schemes for other allocations are given without the explored channel quality indicator offset.

The method may further include transmitting allocation information related to which allocations are for learning purposes.

The method may further include wherein the allocation information is transmitted within downlink control information.

The method may further include wherein the at least one value for the reporting information is learned such that the at least one value satisfies a measurement criteria.

The method may further include wherein the measurement criteria comprises a packet error probability or a signal-to-interference noise ratio.

The method may further include wherein the measurement criteria comprises a block error probability or a block error ratio.

The method may further include wherein the at least one value for the reporting information comprises an offset.

The method may further include wherein learning the at least one value of the reporting information is performed using reinforcement q-learning.

The method may further include deactivating the learning of the reporting information.

The method may further include determining that a subset of one or more user equipments of a plurality of user equipments would benefit most after performing learning exploration; and selecting the subset of the one or more user equipments for learning exploration.

An example apparatus includes at least one processor; and at least one memory including computer program code; wherein the at least one memory and the computer program code are configured to, with the at least one processor, cause the apparatus at least to: transmit an indication of support of learning reporting information; receive a configuration related to the learning of the reporting information, the configuration comprising at least one parameter related to exploration of the reporting information; initiate the exploration of the reporting information to activate the learning of the reporting information; vary at least one value of the reporting information, based on the at least one parameter, to learn the at least one value of the reporting information; and report the at least one value of the reporting information during the learning or following a deactivation of the learning of the at least one value of the reporting information.

An example apparatus includes at least one processor; and at least one memory including computer program code; wherein the at least one memory and the computer program code are configured to, with the at least one processor, cause the apparatus at least to: receive an indication of support of learning reporting information; transmit a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and receive reporting of the at least one value of the reporting information during the learning or following a deactivation of the learning of the at least one value of the reporting information.

An example apparatus includes means for transmitting an indication of support of learning reporting information; means for receiving a configuration related to the learning of the reporting information, the configuration comprising at least one parameter related to exploration of the reporting information; means for initiating the exploration of the reporting information to activate the learning of the reporting information; means for varying at least one value of the reporting information, based on the at least one parameter, to learn the at least one value of the reporting information; and means for reporting the at least one value of the reporting information during the learning or following a deactivation of the learning of the at least one value of the reporting information.

An example apparatus includes means for receiving an indication of support of learning reporting information; means for transmitting a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and means for receiving reporting of the at least one value of the reporting information during the learning or following a deactivation of the learning of the at least one value of the reporting information.

An example non-transitory program storage device readable by a machine, tangibly embodying a program of instructions executable with the machine for performing operations is described/provided, the operations comprising: transmitting an indication of support of learning reporting information; receiving a configuration related to the learning of the reporting information, the configuration comprising at least one parameter related to exploration of the reporting information; initiating the exploration of the reporting information to activate the learning of the reporting information; varying at least one value of the reporting information, based on the at least one parameter, to learn the at least one value of the reporting information; and reporting the at least one value of the reporting information during the learning or following a deactivation of the learning of the at least one value of the reporting information.

An example non-transitory program storage device readable by a machine, tangibly embodying a program of instructions executable with the machine for performing operations is described/provided, the operations comprising: receiving an indication of support of learning reporting information; transmitting a configuration related to the learning of the reporting information, the configuration comprising at least one parameter related to exploration of the reporting information; wherein the exploration of the reporting information is initiated to activate the learning of the reporting information; wherein at least one value of the reporting information is varied, based on the at least one parameter, to learn the at least one value of the reporting information; and receiving reporting of the at least one value of the reporting information during the learning or following a deactivation of the learning of the at least one value of the reporting information.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, this description is intended to embrace all such alternatives, modifications and variances which fall within the scope of the appended claims.

When a reference number as used herein is of the form y-x, this means that the referred to item is an instantiation of (or type of) a common item. For example, module 140-1 and module 140-2 of FIG. 1 are instantiations of (e.g. a first and second instantiation) of a type of module that may be used by the UE 110.

In the figures, lines represent couplings and arrows represent directional couplings or direction of data flow in the case of use for an apparatus, and lines represent couplings and arrows represent transitions or direction of data flow in the case of use for a method or signaling diagram.

The following acronyms and abbreviations that may be found in the specification and/or the drawing figures are defined as follows:
3GPP third generation partnership project
4G fourth generation
5G fifth generation
5GC 5G core network
Alt alternative
AMF access and mobility management function
AR augmented reality
ASIC application-specific integrated circuit
BLEP block error probability
BLER block error ratio
BS base station
CCDF complementary cumulative distribution function
CE control element
CPU central processing unit
CQI channel quality indicator
CRC cyclic redundancy check
CSI channel state information
CU central unit or centralized unit
DCI downlink control information
DL downlink
DSP digital signal processor
DU distributed unit
eNB evolved Node B (e.g., an LTE base station)
EN-DC E-UTRA-NR dual connectivity
en-gNB node providing NR user plane and control plane protocol terminations towards the UE, and acting as a secondary node in EN-DC
E-UTRA evolved universal terrestrial radio access, i.e., the LTE radio access technology
F1 interface between the CU and the DU
FDD frequency division duplex
FPGA field-programmable gate array
FTP file transfer protocol
gNB base station for 5G/NR, i.e., a node providing NR user plane and control plane protocol terminations towards the UE, and connected via the NG interface to the 5GC
HARQ hybrid automatic repeat request
IE information element
I/F interface
I/O input/output
ISD inter-site distance
IP internet protocol
LA learning algorithm
LMF location management function
LTE long term evolution (4G)
M number of vertical antenna elements within a panel, on one polarization
MAC medium access control
MCS modulation coding scheme
Mg number of panels in a column
ML machine learning
MME mobility management entity
MMSE-IRC minimum mean square error—interference rejection combining
Mp number of vertical TXRUs within a panel, on one polarization
N number of horizontal antenna elements within a panel, on one polarization
NCE network control element
ng or NG new generation
Ng number of panels in a row
ng-eNB new generation eNB
NG-RAN new generation radio access network
Np number of horizontal TXRUs within a panel, on one polarization
NR new radio (5G)
N/W network
P number of polarizations
PDA personal digital assistant
PDCP packet data convergence protocol
PDSCH physical downlink shared channel
PEP packet error probability
PHY physical layer
PoC proof-of-concept
PRB physical resource block
Q-learning quality learning (reinforcement learning)
QoS quality of service
RAN radio access network
RB resource block
RE resource element
Rel or REL release
RLC radio link control
RRC radio resource control (protocol)
RRH remote radio head
RU radio unit
Rx receive, receiver, or reception
SCS subcarrier spacing
SGW serving gateway
SINR signal-to-interference-plus-noise ratio
SON self-organizing/optimizing network
TR technical report
TRP transmission and/or reception point
TTI transmission time interval
Tx transmit, transmitter, or transmission
TXRU transceiver unit
UE user equipment (e.g., a wireless, typically mobile device)
UPF user plane function
URLLC ultra-reliable low-latency communication
VR virtual reality
Worst-M minimum CQI value at least in frequency domain
X2 network interface between PAN nodes and between PAN and the core network
Xn or XN network interface between NG-RAN nodes

1. A method comprising:
transmitting an indication of support of learning reporting information;
receiving a configuration related to the learning of the reporting information, the configuration comprising at least one parameter related to exploration of the reporting information;
initiating the exploration of the reporting information to activate the learning of the reporting information;
varying at least one value of the reporting information, based on the at least one parameter, to learn the at least one value of the reporting information; and
reporting the at least one value of the reporting information during the learning or following a deactivation of the learning of the at least one value of the reporting information.

2. The method of claim 1, further comprising receiving exploration permission to explore learning of the at least one value of the reporting information.

3. The method of claim 2, further comprising requesting exploration permission to initiate the exploration of the reporting information prior to receiving exploration permission to explore learning of the at least one value of the reporting information.

4. The method of claim 2, wherein the exploration permission and the configuration are received with a user equipment from a base station.

5. The method of claim 2, wherein the initiating of the exploration of the reporting information occurs upon receiving the exploration permission.

6. The method of claim 2, wherein the exploration permission is valid until exploration is deactivated.

7. The method of claim 1, wherein the exploration is deactivated with a network or with a user equipment.

8. The method of claim 1, wherein the reporting information comprises channel state information or a subset of the channel state information, wherein the subset of the channel state information comprises a channel quality indicator.

9. The method of claim 1, wherein the at least one parameter comprises a time window during which the exploration of the reporting information is to occur.

10. The method of claim 1, wherein the at least one parameter comprises one or more consecutive transmissions during which the exploration of the reporting information is to occur.

11-21. (canceled)

22. The method of claim 1, wherein the at least one parameter comprises an exploration averaging window during which an explored offset value remains constant during exploration.

23. The method of claim 1, wherein the at least one value is reported together with other information of the reporting information, or the at least one value comprises multiple values that are reported together.

24. The method of claim 1, wherein the at least one value is reported separately from other information of the reporting information, or the at least one value comprises multiple values that are reported separately.

25. The method of claim 1, wherein a channel quality indicator offset is calculated within a reported channel quality indicator index value.

26. The method of claim 1, wherein a channel quality indicator offset is reported separately with a separate offset index.

27. The method of claim 1, wherein a user equipment is in one of at least one reporting state, the at least one reporting state comprising a normal state, an exploration state, and a learning state.

28. The method of claim 27, wherein when the user equipment is in the exploration state, the user equipment varies the at least one value of the reporting information during reporting of the reporting information to learn the at least one value of the reporting information.

29. The method of claim 27, wherein when the user equipment is in the learning state, the user equipment continues learning and does not vary the at least one value of the reporting information during reporting of the reporting information.

30. The method of claim 1, further comprising receiving separate data allocations for learning, said separate data allocations utilizing a user equipment reported channel quality indicator with an explored offset for selection of a modulation and coding scheme.

31-39. (canceled)

40. The method of claim 1, wherein:
a subset of one or more user equipments of a plurality of user equipments are determined to benefit most after performing learning exploration; and
wherein the subset of the one or more user equipments is selected for learning exploration.

41-80. (canceled)

81. An apparatus comprising:
at least one processor; and
at least one memory including computer program code;
wherein the at least one memory and the computer program code are configured to, with the at least one processor, cause the apparatus at least to:
transmit an indication of support of learning reporting information;
receive a configuration related to the learning of the reporting information, the configuration comprising at least one parameter related to exploration of the reporting information;
initiate the exploration of the reporting information to activate the learning of the reporting information;
vary at least one value of the reporting information, based on the at least one parameter, to learn the at least one value of the reporting information; and
report the at least one value of the reporting information during the learning or following a deactivation of the learning of the at least one value of the reporting information.

82. An apparatus comprising:
at least one processor; and
at least one memory including computer program code;
wherein the at least one memory and the computer program code are configured to, with the at least one processor, cause the apparatus at least to:
receive an indication of support of learning reporting information;
transmit a configuration related to the learning of the reporting information, the configuration comprising at least one parameter related to exploration of the reporting information;
wherein the exploration of the reporting information is initiated to activate the learning of the reporting information;
wherein at least one value of the reporting information is varied, based on the at least one parameter, to learn the at least one value of the reporting information; and
receive reporting of the at least one value of the reporting information during the learning or following a deactivation of the learning of the at least one value of the reporting information.

83-84. (canceled)

85. A non-transitory program storage device readable by a machine, tangibly embodying a program of instructions executable with the machine for performing operations, the operations comprising:
transmitting an indication of support of learning reporting information;
receiving a configuration related to the learning of the reporting information, the configuration comprising at least one parameter related to exploration of the reporting information;
initiating the exploration of the reporting information to activate the learning of the reporting information;
varying at least one value of the reporting information, based on the at least one parameter, to learn the at least one value of the reporting information; and
reporting the at least one value of the reporting information during the learning or following a deactivation of the learning of the at least one value of the reporting information.

86. (canceled)
